(19) United States
(12) Patent Application Publication
(10) Pub. No.: US 2023/0393304 A1
(43) Pub. Date: Dec. 7, 2023

(54) EL NINO EXTREME WEATHER EARLY WARNING METHOD AND DEVICE BASED ON INCREMENTAL LEARNING

(71) Applicants: TIANJIN UNIVERSITY, Tianjin (CN); Qingdao Marine Science and Technology Center, Qingdao (CN)

(72) Inventors: Anan LIU, Tianjin (CN); Haochun LU, Tianjin (CN); Wenhui LI, Tianjin (CN); Dan SONG, Tianjin (CN); Zhiqiang WEI, Qingdao (CN); Jie NIE, Qingdao (CN); Wensheng ZHANG, Beijing (CN); Zhengya SUN, Beijing (CN)

(21) Appl. No.: 18/133,875

(22) Filed: Apr. 12, 2023

(30) Foreign Application Priority Data
Jun. 1, 2022 (CN) 202210611385.X

(51) Int. Cl. G01W 1/10; G06N 3/09

(52) U.S. Cl. CPC G01W 1/10; G06N 3/09

(57) ABSTRACT

The present invention discloses an El Nino extreme weather warning method based on incremental learning, comprising: through supervised representation learning, selectively constraining, by a multi-scale feature frequency domain distillation technology, drift of low-frequency components of the multi-scale features based on incremental training, and memorizing knowledge learned by the parallel convolutional neural networks in old tasks; adaptively learning different fusion parameters according to different time spans of the input multi-scale data by using a multi-scale feature adaptive fusion technology, so as to enhance the ability to learn new tasks; and outputting a Nino3.4 index reflecting a change rule of El Nino through fully connected layers according to the adaptively fused features, establishing a mapping function of an extreme rainfall probability r based on the Nino3.4 index, and in response to predicting that the value r goes beyond a threshold value k.

### CROSS-REFERENCE TO RELATED APPLICATION

This application claims priority from the Chinese patent application 202210611385.X filed Jun. 1, 2022, the content of which is incorporated herein in the entirety by reference.

### TECHNICAL FELID

The present disclosure relates to the fields of meteorological prediction, prediction of ocean phenomena and incremental learning, in particular to an El Nino extreme weather warning method and device based on incremental learning.

### BACKGROUND

El Nino ^{[1, 2, 3]}, as a cyclical change in an ocean-atmosphere system, is one of the major drivers of the Earth's interannual climate change, which poses significant climatic, environmental and social-economic impacts on a global scale ^{[4]}. El Nino is closely related to the occurrence of global extreme weather disasters and has been valued by academia and related industries. For example, the year following the El Nino event in 1997, that is, in the summer of 1998, watershed type extraordinary rainstorm and flood disasters occurred in the Yangtze River basin and the northeast region of China; and due to the El Nino event that began in 2014, the national average precipitation in winter of China in 2015 grew by more than 50% as against that in the same period throughout the year, which set the highest record in history, and the Yangtze River basin and the Jiangnan area were highly susceptible to flood disasters. During extreme rainstorms, transmission line pole tower bases, transformers, substations and other important power facilities are likely to be intruded by water, and even fires leading to a large area of power outage are caused, affecting the safe and stable operation of power grids.

In recent years, in order to prevent extreme weather and reduce its impacts on human production and life, researchers around the world have been working to improve the prediction level of global climate by using neural network-based representation learning. For example, the occurrence of El Nino is associated with slow ocean change and its coupling with the atmosphere, showing that it is feasible to use convolutional neural networks to predict the El Nino event in advance and thus provide early warning on extreme weather arising therefrom, such as rainstorms [^{5]}. However, there is little work on the prediction of extreme rainfall under the influence of El Nino at present, and the work for improving the neural network-based prediction level of El Nino extreme weather by using incremental learning ^{[6, 7]} has not been carried out, for example, the work for accurate prediction of extreme rainfall under the influence of El Nino by using incremental learning and the work of early warning for disaster prevention and early warning on power grids have not been carried out yet.

### SUMMARY

Disclosed are an El Nino extreme weather warning method and device based on incremental learning. The present disclosure is dedicated to improving the neural network-based prediction level of El Nino extreme weather, and solving the problems of insufficient expandability and the lack of temporal and spatial inheritance of a traditional convolutional neural network in the face of continuously emerging new data and the problem of the difference between long-term prediction and short-term prediction of extreme rainfall, for example, the prediction accuracy of the precipitation along transmission lines under incremental El Nino may be effectively improved to relieve natural disasters. The detailed description is given as follows:

In a first aspect, an El Nino extreme weather warning method based on incremental learning, includes:

down-sampling marine data to obtain multi-scale marine data, and dividing the multi-scale data into a plurality of task sequences bounded by a preset year;

inputting the task sequences into parallel convolutional neural networks in a data flow form, and extracting multi-scale features through supervised representation learning;

selectively constraining drift of low-frequency components of the multi-scale features by using a multi-scale feature frequency domain distillation technology based on incremental training, and memorizing knowledge learned by the parallel convolutional neural networks in old tasks;

adaptively learning different fusion parameters according to different time spans of the input multi-scale data by using a multi-scale feature adaptive fusion technology, so as to enhance the ability to learn new tasks; and

outputting a Nino3.4 index reflecting a change rule of El Nino through fully connected layers according to the adaptively fused features, establishing a mapping function of an extreme rainfall probability r based on the Nino3.4 index, and in response to predicting that the value r goes beyond a threshold value k, carrying out rainstorm early warning, and carrying out rainstorm prevention and control of transmission lines in advance.

Wherein the multi-scale feature frequency domain distillation technology is used for making the output features of a new parallel network close to the output features of an old parallel network.

Wherein the multi-scale feature adaptive fusion technology includes multi-scale parallel networks, two bottleneck layers, two fully connected layers and one adaptive fusion function.

Furthermore, the selectively constraining the drift of the low-frequency components of the multi-scale features by using the multi-scale feature frequency domain distillation technology, and the memorizing the knowledge learned by the parallel convolutional neural networks in the old tasks are specifically as follows:

initializing a new parallel network Ω^{t} by using parameters of an old parallel network already trained in a last training phase when training new tasks every time, freezing the parameters of the old parallel network Ω^{t-1}, and simultaneously inputting training data into the new and old parallel networks;

performing discrete cosine transform on the multi-scale features hₜⁿ and hₜ₋₁ⁿ output by the new and old parallel networks, and drawing close to a Euclidean distance between the low-frequency components of the multi-scale features to constrain evolution of the features; and

defining the Euclidean distance as a multi-scale feature frequency domain distillation loss function:

$${L}_{dct - distillation} = {\sum }_{k = 1}^{K} {\sum }_{n = 1}^{2} ‖ {h}_{t}^{n , k} - {h}_{t - 1}^{n , k} ‖$$

Where, t represents a training phase, hₜ^{n,k} represents first k low-frequency components of the output features of the new parallel network, hₜ₋₁^{n,k} represents first k low-frequency components of the output features of the old parallel network, and K is a length of a feature vector hₜⁿ.

Furthermore, the old parallel network is a network already trained in a t-1th training phase;

the new parallel network is a new parallel network for initializing parameters through the network trained in the last phase, which is used for training in a current t^{th} training phase; and the parameters of the old parallel network are frozen in the whole new training phase, so as to facilitate training of the new parallel network, and the old parallel network is deleted after the new parallel network is trained.

Wherein the adaptive fusion function is:

α₁=ζ(hₜ¹)=sigmoid(log(abs(ƒₛ(hₜ¹))))

α₂=ζ(hₜ²)=sigmoid(log(abs(ƒₛ(hₜ²))))

Where, α₁ is importance of large-scale features to a final result, α₂ is importance of small-scale features to the final result, abs and log functions aim to distinguish large or small input values more significantly, a sigmoid function aims to map values of α₁ and α₂ to an interval (0, 1), and ƒₛ is a scoring layer used for outputting importance of each scale feature;

h_{fusion}=α₁hₜ¹+α₂hₜ²

Where, h_{fusion} is a final feature obtained after adaptive fusion of multi-scale features, hₜ¹ represents an original large-scale feature, which is more suitable for short-term prediction, and hₜ² represents an original small-scale feature.

In a second aspect, an El Nino extreme weather warning device based on incremental learning, includes:

a module for dividing a plurality of task sequences, configured to down-sample marine data to obtain multi-scale marine data, and divide the multi-scale data into the plurality of task sequences bounded by a preset year; a module for extracting multi-scale features, configured to input the task sequences into parallel convolutional neural networks in a data flow form, and extract the multi-scale features through supervised representation learning; an incremental training module, configured to selectively constrain drift of low-frequency components of the multi-scale features by using a multi-scale feature frequency domain distillation technology based on incremental training, and memorize knowledge learned by the parallel convolutional neural networks in old tasks; an adaptive fusion module, configured to adaptively learn different fusion parameters according to different time spans of the input multi-scale data by using a multi-scale feature adaptive fusion technology, so as to enhance the ability to learn new tasks; and an early warning module, configured to output a Nino3.4 index reflecting a change rule of one ocean phenomenon through fully connected layers according to the adaptively fused features, establish a mapping function of an extreme rainfall probability r based on the Nino3.4 index, and in response to predicting that the value r goes beyond a threshold value k, carry out rainstorm early warning, and carry out rainstorm prevention and control of transmission lines in advance.

In a third aspect, an El Nino extreme weather early device based on incremental learning, includes: a processor and a memory storing program instructions, wherein the processor calls the program instructions stored in the memory to enable the device to implement the steps of the method according to any one of the first aspect.

In a fourth aspect, provided is a computer readable storage medium storing computer programs, wherein the computer programs include program instructions, and when the program instructions are executed by a processor, the process implements the steps of the method according to any one of the first aspect.

The technical solutions provided by the present disclosure have the following beneficial effects:

1. The fields of incremental learning, El Nino and rainfall prediction and early warning are inventively combined in the present invention, and an existing prediction method based on deep learning requires one-time training on a closed database, which is time-consuming and computationally intensive, and hardly adapts to new marine data online, leading to very limited practicality; and in the present invention, based on incremental learning, a marine data representation learning model based on neural networks can incrementally learn and mine the change rule in emerging marine data while maintaining the memory and consolidation of old knowledge already learned, thereby making up blind spots of previous studies and improving the deployment capacity of prediction of the precipitation along the transmission lines under El Nino in the real world;

2. The multi-scale feature frequency domain distillation technology is introduced into the present disclosure to perform discrete cosine transform on the features extracted from the new parallel network and the old parallel network, so as to obtain a series of orthorhombic feature components, perform distillation through the Euclidean distance at a feature level to match low-frequency feature components output by the new and old parallel networks, which further constrains updating of network parameters for relieving catastrophic forgetting as much as possible.

3. The multi-scale feature adaptive fusion technology is introduced into the present invention, which adaptively learns fusion parameters of the multi-scale features according to long-term and short-term prediction tasks, so as to improve the capacity to learn the new task, make up the blind spots of previous studies, improve the neural-network-based prediction level of extreme climate, for example, effectively improve the prediction accuracy of the precipitation along the transmission lines under incremental El Nino to relieve natural disasters.

### BRIEF DESCRIPTION OF THE DRAWINGS

FIG. 1 is a flowchart of an El Nino extreme weather warning method based on incremental learning;

FIG. 2 is a network structure diagram of an El Nino extreme weather warning method based on incremental learning;

FIG. 3 is a mapping function diagram of an El Nino extreme weather warning method based on incremental learning;

FIG. 4 is a schematic structural diagram of an El Nino extreme weather warning device based on incremental learning; and

FIG. 5 is another schematic structural diagram of an El Nino extreme weather warning device based on incremental learning.

### DETAILED DESCRIPTION OF THE PRESENT INVENTION

To make the objectives, technical solutions and advantages of the present disclosure clearer, the implementations of the present disclosure will be described in detail below.

It can be know from analysis on the background art that when a large amount of emerging marine data needs to be learned, neural networks can obtain a Nino3.4 index value of a target month while keeping memorizing old knowledge (the change rule of the marine data already learned) and learning new knowledge (change rule of new marine data), and then the precipitation along transmission lines in the target month is predicted according to the Nino3.4 index value, so as to carry out early warning of extreme rainfall and prevention and reduction of natural disasters in advance.

1. It is worth making intensive research on how to learn the change rule in the incrementally emerging new marine data in real time while maintaining the old knowledge, and to grasp the non-linear temporal and spatial correlation between relevant factors and the precipitation along the transmission lines under El Nino in general; and

2. how to construct the correspondence between different pre-prediction times and network structures.

An embodiment of the present disclosure designs a multi-scale input parallel neural network as a backbone network, and a multi-scale feature frequency domain distillation technology and a multi-scale feature adaptive fusion technology are introduced into the parallel neural network, so that the problems that when processing incrementally emerging marine data flow, an existing method cannot adapt to new data online or is simple and rough in structure are successfully solved. On this basis, adaptive differential processing for long-term and short-term prediction is added, and attention to temporal and spatial inheritance of knowledge is increased, so that the marine data representation learning level is improved. The precipitation along the transmission lines in a certain month is determined according to the Nino3.4 index value output by the parallel neural network, so as to carry out rainstorm early warning and prevention and reduction of natural disasters in advance.

### Embodiment 1

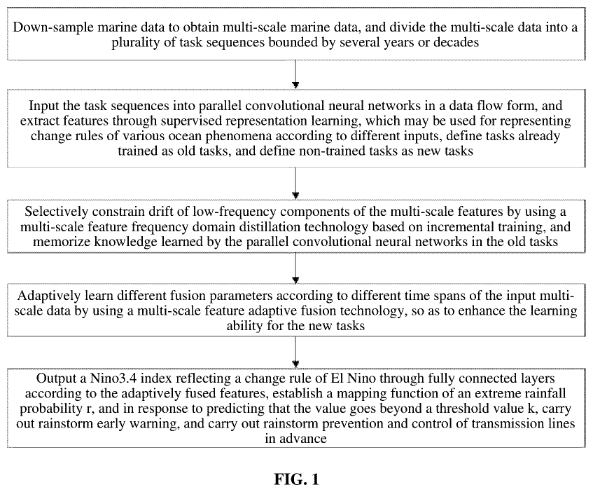

Referring to FIG. 1, an El Nino extreme weather warning method based on incremental learning, includes the following steps:

101: Marine data is down-sampled to obtain multi-scale marine data, and the multi-scale data is divided into a plurality of task sequences bounded by several years or decades;

wherein in the embodiment of the present invention, El Nino is taken as an example, and the multi-scale data is multi-scale sea surface temperature and heat content diagrams.

102: The task sequences are input into parallel convolutional neural networks in a data flow form, and multi-scale features are extracted through supervised representation learning;

wherein the above multi-scale features can be used for representing change rules of various ocean phenomena according to different inputs of the parallel convolutional neural networks, tasks already trained are called old tasks, and non-trained tasks are called new tasks; and the embodiment of the present disclosure is described by taking El Nino as an example, and may also be applied to other natural phenomena during specific implementation, which is not described in detail.

103: Incremental training [^{5]} is performed, drift of low-frequency components of the multi-scale features is selectively constrained by using a multi-scale feature frequency domain distillation technology, and knowledge learned by the parallel convolutional neural networks in the old tasks is accurately and effectively memorized, so as to reduce forgetting;

wherein the multi-scale feature frequency domain distillation technology includes: an old parallel network Ω^{t-1}, a new parallel network Ω^{t} and a multi-scale frequency domain distillation function for linking therebetween, and the multi-scale frequency domain distillation function is used for making the output features of the new parallel network Ω^{t} close to the output features of the old parallel network Ω^{t-1}.

An existing marine data representation learning method requires one-time training on a closed dataset, which is time-consuming and computationally intensive, and hardly adapts to new marine data online, leading to very limited practicality and reliability. Therefore, the method draws on knowledge of incremental learning to overcome the defects of previous studies.

104: Different fusion parameters are adaptively learned according to different time spans of the input multi-scale data by using a multi-scale feature adaptive fusion technology, so as to enhance the learning ability for the new tasks;

wherein the multi-scale feature adaptive fusion technology includes multi-scale parallel networks, two bottleneck layers, two fully connected layers and one adaptive fusion function ζ(⋅).

The embodiment of the present disclosure focuses on the demand difference of long-term and short-term prediction tasks for the multi-scale data. The problem that the method in the prior art is too simple to have insufficient adaptability to the new marine data is solved based on adaptive learning of the fusion parameters of the multi-scale features.

105: A specific quantized value of a change rule of one ocean phenomenon is output through the fully connected layers according to the adaptively fused features, and a Nino3.4 index is output here by taking El Nino as an example;

wherein the Nino3.4 index is a mean sea surface temperature anomaly index of a Nino3.4 region (170° W-120° W, 5° S-5° N) in the Pacific Ocean, and it is defined as an El Nino event in response to determining that the Nino3.4 index goes beyond 0.5° C. for 5 consecutive months.

106: A monthly average maximum precipitation and extreme rainfall in the current month along transmission lines in Shandong Province over the past 50 years are collected, and in combination with a change rule of the Nino3.4 index over the past 50 years, a mapping function ϵ(⋅) of the Nino3.4 index and a probability r of the extreme rainfall is established; and a threshold value k of a mapping value of the Nino3.4 index is found, and the extreme rainfall is very likely to occur in the current month once the predicted value r goes beyond the threshold value k.

107: Different previous months m are designed, the Nino3.4 index behind the month m can be obtained by inputting SST and HC diagrams for 3 consecutive months into the parallel convolutional neural networks, the result is compared with the threshold value k through the mapping function, and if the result is greater than k, rainstorm early warning is carried out, and rainstorm prevention and control of the transmission lines is carried out in advance.

In conclusion, the embodiment of the present disclosure makes up the blind spots of previous studies through the above steps 101-107, can improve the neural-network-based prediction level of extreme climate, for example, can effectively improve the prediction accuracy of the precipitation along the transmission lines under incremental El Nino to relieve natural disasters.

### Embodiment 2

The solution in Embodiment 1 will be further described below with reference to specific examples and calculation formulas, and the detailed description is given as follows:

201: Marine data is down-sampled to obtain multi-scale marine data, and the multi-scale data is divided into a plurality of task sequences with several years or decades as a boundary;

wherein the above step 201 mainly includes:

wherein taking prediction of El Nino as an example, the specific operation of dividing the task sequences is exemplified by a coupling model comparison project (Phase 5) (CMTPS) database from 1861 to 2004, and data of 140 years is taken out in the embodiment of the present disclosure and can be arbitrarily divided into a plurality of tasks, for example, one task contains data of 20 years, only one task is trained in each incremental training phase, and all the tasks are trained in 7 phases.

202: The task sequences are input into parallel convolutional neural networks in a data flow form, and multi-scale features are extracted through supervised representation learning, wherein the multi-scale features can be used for representing change rules of various ocean phenomena according to different inputs of the parallel convolutional neural networks, tasks already trained are called old tasks, and non-trained tasks are called new tasks; and

the convolutional neural networks have made outstanding achievements in processing multi-dimensional array data (color images) with spatial structures. Thus, the convolutional neural networks can be used for revealing the relation between a three-dimensional prediction field and a prediction index. In the embodiment of the present invention, an input of the parallel convolutional neural networks is denoted as x, a feature extraction function is denoted as Tⁿ(⋅), and an output function of fully connected layers is denoted as F(⋅), where, n represents an n^{th} branch of the parallel convolutional neural networks. Taking prediction of El Nino as an example, SST and HC diagrams for 3 consecutive months are taken as inputs in the embodiment of the present invention, so that an output feature h can be obtained:

hⁿ=Tⁿ(x),n∈(1,2) (1)

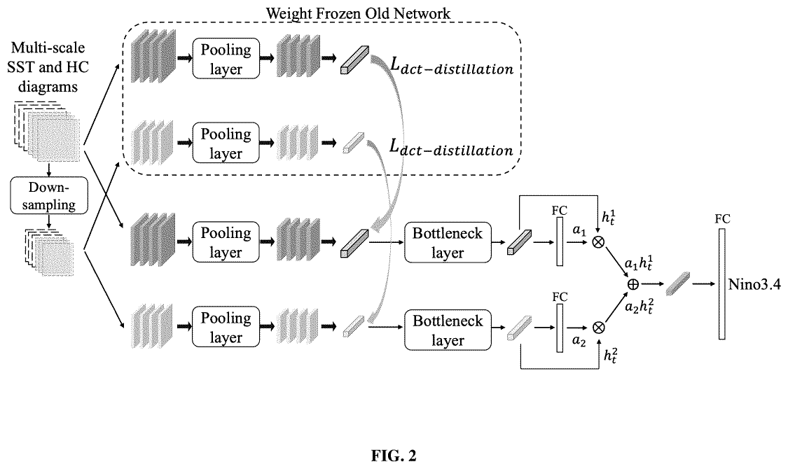

203: Incremental training ^{[}5] is performed, drift of low-frequency components of the multi-scale features is selectively constrained by using a multi-scale feature frequency domain distillation technology, and knowledge learned by the parallel convolutional neural networks in the old tasks is accurately and effectively memorized, so as to reduce forgetting;

wherein a new parallel network Ω^{t} is initialized by using parameters of an old parallel network Ω^{t-1} already trained in a last training phase when new tasks are trained every time, the parameters of the old parallel network Ω^{t-1} are frozen, and training data is simultaneously input into the new and old parallel networks. Referring to FIG. 2, discrete cosine transform is performed on the multi-scale features hₜⁿ and hₜ₋₁ⁿ (n∈(1, 2)) output by the new and old parallel networks, and a Euclidean distance between the low-frequency components of the multi-scale features is drawn close to constrain evolution of the features.

The Euclidean distance is defined as a multi-scale feature frequency domain distillation loss function:

L_{dct-distillation}Σₖ₌₁^{K}Σₙ₌₁²∥hₜ^{n,k}−hₜ₋₁^{n,k}∥ (2)

Where, t represents a t^{th} training phase, hₜ^{n,k} represents first k low-frequency components of the output features of the new parallel network, hₜ₋₁^{n,k} represents first k low-frequency components of the output features of the old parallel network, n=1 corresponds to a large-scale network branch, n=2 corresponds to a small-scale network branch, and K is a length of a feature vector hₜⁿ.

Wherein the large-scale network branch uses a convolution kernel with a size of 4×4, with large-scale sea surface temperature (SST) and heat content (HC) diagrams with a size of 72×24 as an input; and the small-scale network branch uses a convolution kernel with a size of 2×2, with down-sampled small-scale sea surface temperature (SST) and heat content (HC) diagrams with a size of 54×18 as an input.

Wherein the old parallel network Ω^{t-1} is a network already trained in a last training phase (namely, t-1th training phase); and the new parallel network Ω^{t} is a new parallel network for initializing parameters through the network trained in the last phase, which is used for training in a current phase (t^{th} training phase). The new parallel network and the old parallel network differ in that the parameters of the old parallel network are frozen in the whole new training phase, so as to facilitate training of the new parallel network, and the old parallel network is deleted after the new parallel network is trained. The multi-scale feature frequency domain distillation technology has the good effect on maintaining a stable representation, inheriting old knowledge and resisting catastrophic forgetting.

204: Different fusion parameters are adaptively learned according to different time spans of the input multi-scale data by using a multi-scale feature adaptive fusion technology, so as to enhance the ability to learn the new tasks;

wherein dimensions of features h¹ and h² output by two branches of the new parallel network are aligned through the two bottleneck layers f_{b1} and f_{b2}, and the bottleneck layers are technical terms known in the art, which are not repeated in the embodiment of the present invention. One scoring layer (namely, fully connected layer) fₛ is input into each of the multi-scale features with the aligned dimensions, and the scoring layers fₛ are to output importance of each scale feature.

Then, a function ζ(⋅) is defined in the embodiment of the present disclosure to quantify importance of each scale feature to the final predication of the accuracy of the Nino3.4 index:

α₁=ζ(hₜ¹)=sigmoid(log(abs(ƒₛ(hₜ¹)))) (3)

α₂=ζ(hₜ²)=sigmoid(log(abs(ƒₛ(hₜ²)))) (4)

Where,

α₁ is importance of large-scale features to a final result, α₂ is importance of small-scale features to the final result, abs and log functions aim to distinguish large or small input values more significantly, and a sigmoid function aims to map values of α₁ and α₂ to an interval (0, 1). Adaptive fusion of the multi-scale features may be performed after importance scores of the large-scale features (namely, features obtained after large-scale input data is output from large-scale network branches) and the small-scale features (namely, features obtained after small-scale input data is output from small-scale network branches) are obtained:

h_{fusion}=α₁hₜ¹+α₂hₜ² (5)

Where, h_{fusion} is a final feature obtained after adaptive fusion of the multi-scale features, hₜ¹ represents an original large-scale feature, which is more suitable for short-term prediction, hₜ² represents an original small-scale feature, which is more suitable for long-term prediction, and t represents a tth training phase.

An existing incremental learning technology either only considers adding regularization terms to constrain change in network parameters, or only considers simply improving the learning capacity of the new data. However, the embodiment of the present disclosure simultaneously considers both of them and considers the mapping relation between multi-scale inputs and prediction time scales, thereby improving the performance of an incremental El Nino extreme weather prediction algorithm.

205: A specific quantized value of a change rule of one ocean phenomenon is output through the fully connected layers according to the adaptively fused features, and a Nino3.4 index is output here by taking El Nino as an example;

y=Fⁿ(h_{fusion}) (6)

Where, h_{fusion} is a feature obtained after adaptive fusion, F(⋅) is fully connected layers, and y represents an output of the fully connected layers.

In the embodiment of the present invention, by means of multi-scale feature frequency domain distillation and multi-scale feature adaptive fusion, the change rule in the new marine data may be efficiently learned and mined while inheriting the old knowledge, thereby solving the problem of catastrophic forgetting in incremental learning. Meanwhile, incremental learning and marine data representation learning are combined in the embodiment of the present disclosure for the first time to meet requirements in actual application. The specific application mode of the embodiment of the present disclosure is described by taking El Nino as an example.

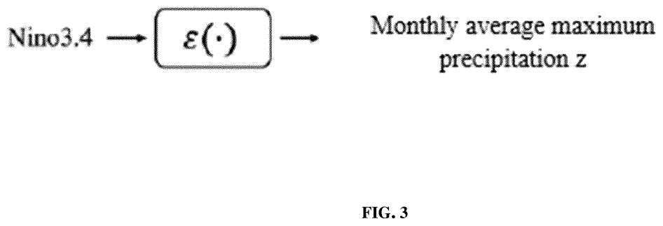

206: As shown in FIG. 3, a monthly average maximum precipitation and extreme rainfall in the current month along transmission lines in Shandong Province over the past 50 years are collected, and in combination with a change rule of the Nino3.4 index over the past 50 years, a mapping function ϵ(⋅) of the Nino3.4 index and a probability r of the extreme rainfall is established; and a threshold value k of a mapping value of the Nino3.4 index is found, and the extreme rainfall is very likely to occur in the current month once the predicted value r goes beyond the threshold value k.

r=ϵ (7)

Where, r represents the mapping value of the Nino3.4 index value, namely the probability of the extreme rainfall along the transmission lines in a certain target month, and y represents the Nino3.4 index value in the target month.

207: Different previous months m are designed, the Nino3.4 index behind the month m can be obtained by inputting SST and HC diagrams for 3 consecutive months into the parallel convolutional neural networks, the result is compared with the threshold value k through the mapping function, and if the result is greater than k, rainstorm early warning is carried out, and rainstorm prevention and control of the transmission lines is carried out in advance.

For example, July 2016 is selected as the target month in the embodiment of the present invention, m is set as 5, then SST and HC diagrams of November and December 2015 and January 2016 need to be input into the parallel convolutional neural networks to predict a Nino3.4 index after 5 months, it is found that the result is greater than the threshold value k through the mapping function ϵ(⋅), and rainstorm early warning of the transmission lines may be achieved ahead of 5 months, thereby reducing the occurrence of natural disasters on the transmission lines or personal casualties and other conditions caused by line collapse and the like.

In conclusion, the embodiment of the present disclosure makes up the blind spots of previous studies through the above steps 201-207, may improve the neural-network-based prediction level of extreme climate, for example, may effectively improve the prediction accuracy of the precipitation along the transmission lines under incremental El Nino to relieve natural disasters.

### Embodiment 3

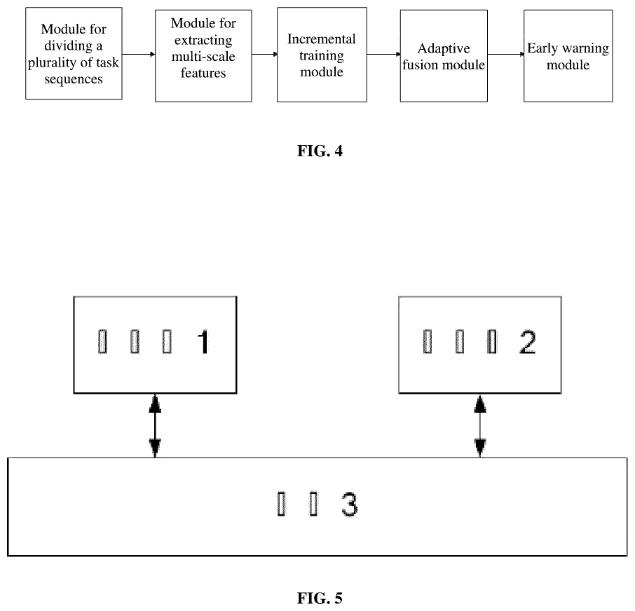

Referring to FIG. 4, an El Nino extreme weather warning device based on incremental learning, includes:

a module for dividing a plurality of task sequences, configured to down-sample marine data to obtain multi-scale marine data, and divide the multi-scale data into the plurality of task sequences bounded by a preset year;

a module for extracting multi-scale features, configured to input the task sequences into parallel convolutional neural networks in a data flow form, and extract the multi-scale features through supervised representation learning;

an incremental training module, configured to selectively constrain drift of low-frequency components of the multi-scale features by using a multi-scale feature frequency domain distillation technology based on incremental training, and memorize knowledge learned by the parallel convolutional neural networks in old tasks;

an adaptive fusion module, configured to adaptively learn different fusion parameters according to different time spans of the input multi-scale data by using a multi-scale feature adaptive fusion technology, so as to enhance the ability to learn new tasks; and

an early warning module, configured to output a Nino3.4 index reflecting a change rule of one ocean phenomenon through fully connected layers according to the adaptively fused features, establish a mapping function of an extreme rainfall probability r based on the Nino3.4 index, and in response to predicting that the value r goes beyond a threshold value k, carry out rainstorm early warning, and carry out rainstorm prevention and control of transmission lines in advance.

It should be noted that the description of the device in the above embodiment corresponds to that of the method in the embodiment, which is not repeated in the embodiment of the present invention.

In conclusion, the embodiment of the present disclosure may effectively improve the prediction accuracy of the precipitation along the transmission lines under incremental El Nino to relieve natural disasters through the above modules.

### Embodiment 4

Referring to FIG. 5, an El Nino extreme weather early device based on incremental learning, includes: a processor and a memory storing program instructions, and the processor calls the program instructions stored in the memory to enable the device to implement the steps of the method in Embodiment 1:

marine data is down-sampled to obtain multi-scale marine data, and the multi-scale data is divided into a plurality of task sequences bounded by a preset year; the task sequences are input into parallel convolutional neural networks in a data flow form, and multi-scale features are extracted through supervised representation learning; drift of low-frequency components of the multi-scale features is selectively constrained by using a multi-scale feature frequency domain distillation technology based on incremental training, and knowledge learned by the parallel convolutional neural networks in old tasks is memorized;

different fusion parameters are adaptively learned according to different time spans of the input multi-scale data by using a multi-scale feature adaptive fusion technology, so as to enhance the ability to learn the new tasks; and

a Nino3.4 index reflecting a change rule of one ocean phenomenon is output through fully connected layers according to the adaptively fused features, a mapping function of an extreme rainfall probability r is established based on the Nino3.4 index, and in response to predicting that the value r goes beyond a threshold value k, rainstorm early warning is carried out, and rainstorm prevention and control of transmission lines are carried out in advance.

Wherein the multi-scale feature frequency domain distillation technology is used for making the output features of a new parallel network close to the output features of an old parallel network.

Wherein the multi-scale feature adaptive fusion technology includes multi-scale parallel networks, two bottleneck layers, two fully connected layers and one adaptive fusion function.

Furthermore, the selectively constraining drift of the low-frequency components of the multi-scale features by using the multi-scale feature frequency domain distillation technology, and the memorizing the knowledge learned by the parallel convolutional neural networks in the old tasks are specifically as follows:

a new parallel network Ω^{t} is initialized by using parameters of the old parallel network already trained in a last training phase when new tasks are trained every time, the parameters of the old parallel network Ω^{t-1} are frozen, and training data is simultaneously input into the new and old parallel networks;

discrete cosine transform is performed on the multi-scale features hₜⁿ and hₜ₋₁ⁿ output by the new and old parallel networks, and a Euclidean distance is drawn close between the low-frequency components of the multi-scale features to constrain evolution of the features; and

the Euclidean distance is defined as a multi-scale feature frequency domain distillation loss function:

$${L}_{dct - distillation} = {\sum }_{k = 1}^{K} {\sum }_{n = 1}^{2} ‖ {h}_{t}^{n , k} - {h}_{t - 1}^{n , k} ‖$$

Where, t represents a training phase, hₜ^{n,k} represents first k low-frequency components of the output features of the new parallel network, hₜ₋₁^{n,k} represents first k low-frequency components of the output features of the old parallel network, and K is a length of a feature vector hₜⁿ.

Furthermore, the old parallel network is a network already trained in a t-1th training phase; and the new parallel network is a new parallel network for initializing parameters through the network trained in the last phase, which is used for training in a current t^{th} training phase; and the parameters of the old parallel network are frozen in the whole new training phase, so as to facilitate training of the new parallel network, and the old parallel network is deleted after the new parallel network is trained.

Wherein the adaptive fusion function is:

α₁=ζ(hₜ¹)=sigmoid(log(abs(ƒₛ(hₜ¹))))

α₂=ζ(hₜ²)=sigmoid(log(abs(ƒₛ(hₜ²))))

α₁ is importance of large-scale features to a final result, α₂ is importance of small-scale features to the final result, abs and log functions aim to distinguish large or small input values more significantly, a sigmoid function aims to map values of α₁ and α₂ to an interval (0, 1), and ƒₛ is a scoring layer used for outputting importance of each scale feature;

h_{fusion}=α₁hₜ¹+α₂hₜ²

Where, h_{fusion} is a final feature obtained after adaptive fusion of multi-scale features, hₜ¹ represents an original large-scale feature, which is more suitable for short-term prediction, and hₜ² represents an original small-scale feature.

It should be noted here that the description of the device in the above embodiment corresponds to that of the method in the embodiment, which is not repeated in the embodiment of the present invention.

An executing main body of the processor 1 and the memory 2 may be a computer, a single-chip microcomputer, a microcontroller and other devices with computing functions. The executing main body is not limited to the embodiment of the present disclosure during specific implementation, which is selected according to requirements in actual application.

The memory 2 and the processor 1 transmit data signals through a bus 3, which is not repeated in the embodiment of the present invention.

Based on the same inventive concept, an embodiment of the present disclosure further provides a computer readable storage medium including stored programs, and when the programs run, equipment where the storage medium is located is controlled to implement the steps of the method in the above embodiment.

The computer readable storage medium includes but is not limited to a flash memory, a hard disk, a solid state disk and the like.

It should be noted that the description of the readable storage medium in the above embodiment corresponds to that of the method in the embodiment, which is not repeated in the embodiment of the present invention.

In the above embodiment, the implementation may be achieved in whole or in part by software, hardware, firmware, or any combination thereof. When achieved by the software, the implementation may be achieved in whole or in part in the form of a computer program product. The computer program product includes one or more computer instructions. When the computer program instructions are loaded and executed on a computer, flows or functions of the embodiment of the present disclosure are generated in whole or in part.

The computer may be a general-purpose computer, a special-purpose computer, a computer network or other programmable devices. The computer instructions may be stored in the computer readable storage medium or transmitted through the computer readable storage medium. The computer readable storage medium may be any available medium capable of being accessed by the computer or data storage equipment such as a server and a data center, which incorporates one or more available media. The available medium may be a magnetic medium or a semiconductor medium and the like.

### REFERENCES

[1] Ham, Y G. , Kim, J H. & Luo, J J. Deep learning for multi-year ENSO forecasts [J]. Nature 573, 568-572 (2019).

[2] Peng Jiayi. Research on Influence of ENSO on Western Pacific Subtropical High and Interaction with East Asian Monsoon [D]. Nanjing Institute of Meteorology, 1999.

[3] Han Wentao. Research on the Interdecadal Variation in the Response of Winter and Summer Temperature in China to ENSO in Recent Fifty Years [D]. Nanjing University of Information Science & Technology, 2013.

[4] Chen , H C. , Tseng , Y H. , Hu , Z Z. et al. Enhancing the ENSO Predictability beyond the Spring Barrier [J]. Sci Rep 10, 984 (2020).

[5] Yan J, Mu L, Wang L, et al. Temporal Convolutional Networks for the Advance Prediction of ENSO [J]. Scientific Reports, 2020, 10(1):8055.

[6] S. Rebuffi, A. Kolesnikov, , G. Sperl, and C. H. Lampert. icarl: Incremental classifier and representation learning [J] . CVPR, 2017.

[7] Li Z, Hoiem D. Learning without forgetting [J]. IEEE transactions on pattern analysis and machine intelligence, 2017, 40(12): 2935-2947.

The embodiment of the present disclosure does not limit models of other devices except for those specifically specified, as long as the devices can complete the above functions.

Those skilled in the art can understand that the drawings are only schematic diagrams of a preferred embodiment. The serial number of the above embodiments of the present disclosure is merely provided for description, and does not represent the advantages and disadvantages of the embodiments.

The above descriptions are merely preferred embodiments of the present invention, which are not intended to limit the present invention. Any modification, equivalent replacement, improvement and the like made within the spirit and principle of the present disclosure should fall within the scope of protection of the present invention.

1. A weather warning method based on incremental learning, comprising the steps:
down-sampling marine data to obtain multi-scale marine data, and dividing the multi-scale data into a plurality of task sequences bounded by a preset year;
inputting the task sequences into parallel convolutional neural networks in a data flow form, and extracting multi-scale features through supervised representation learning;
selectively constraining, by a multi-scale feature frequency domain distillation technology, drift of low-frequency components of the multi-scale features based on incremental training, and memorizing knowledge learned by the parallel convolutional neural networks in old tasks;
adaptively learning different fusion parameters according to different time spans of the input multi-scale data by using a multi-scale feature adaptive fusion technology, so as to enhance the ability to learn new tasks; and
outputting a Nino3.4 index reflecting a change rule of El Nino through fully connected layers according to the adaptively fused features, establishing a mapping function of an extreme rainfall probability r based on the Nino3.4 index, and in response to predicting that the value r goes beyond a threshold value k, carrying out rainstorm early warning, and carrying out rainstorm prevention and control of transmission lines in advance.

2. The weather warning method based on incremental learning according to claim 1, wherein the multi-scale feature frequency domain distillation technology is used for making the output features of the new parallel network close to the output features of the old parallel network.

3. The weather warning method based on incremental learning according to claim 1, wherein the multi-scale feature adaptive fusion technology comprises: multi-scale parallel networks, two bottleneck layers, two fully connected layers and one adaptive fusion function.

4. The weather warning method based on incremental learning according to claim 1, wherein the selectively constraining the drift of the low-frequency components of the multi-scale features by using the multi-scale feature frequency domain distillation technology, and the memorizing the knowledge learned by the parallel convolutional neural networks in the old tasks are specifically as follows:
initializing a new parallel network Ω^{t} by using parameters of an old parallel network already trained in a last training phase when training new tasks every time, freezing the parameters of the old parallel network Ω^{t-1}, and simultaneously inputting training data into the new and old parallel networks;
performing discrete cosine transform on the multi-scale features hₜⁿ and hₜ₋₁ⁿ output by the new and old parallel networks, and drawing close to a Euclidean distance between the low-frequency components of the multi-scale features to constrain evolution of the features; and
defining the Euclidean distance as a multi-scale feature frequency domain distillation loss function:
$${L}_{dct - distillation} = {\sum }_{k = 1}^{K} {\sum }_{n = 1}^{2} ‖ {h}_{t}^{n , k} - {h}_{t - 1}^{n , k} ‖$$
where, t represents a training phase, hₜ^{n,k} represents first k low-frequency components of the output features of the new parallel network, hₜ₋₁^{n,k} represents first k low-frequency components of the output features of the old parallel network, and K is a length of a feature vector hₜⁿ.

5. The weather warning method based on incremental learning according to claim 4, wherein
the old parallel network is a network already trained in a t-1th training phase;
the new parallel network is a new parallel network for initializing parameters through the network trained in the last phase, which is used for training in a current tth training phase; and
the parameters of the old parallel network are frozen in the whole new training phase to facilitate training of the new parallel network, and the old parallel network is deleted after the new parallel network is trained.

6. The weather warning method based on incremental learning according to claim 3, wherein the adaptive fusion function is:
α₁=ζ(hₜ¹)=sigmoid(log(abs(ƒₛ(hₜ¹))))
α₂=ζ(hₜ²)=sigmoid(log(abs(ƒₛ(hₜ²))))
α₁ is importance of large-scale features to a final result, α₂ is importance of small-scale features to the final result, abs and log functions aim to distinguish large or small input values more significantly, a sigmoid function aims to map values of α₁ and α₂ to an interval (0, 1), and ƒₛ is a scoring layer used for outputting importance of each scale feature;
h_{fusion}=α₁hₜ¹+α₂hₜ²
where, h_{fusion} is a final feature obtained after adaptive fusion of the multi-scale features, hₜ¹ represents an original large-scale feature, which is more suitable for short-term prediction, and hₜ² represents an original small-scale feature.

7. A weather early device based on incremental learning, comprising:
a module for dividing a plurality of task sequences, configured to down-sample marine data to obtain multi-scale marine data, and divide the multi-scale data into the plurality of task sequences bounded by a preset year;
a module for extracting multi-scale features, configured to input the task sequences into parallel convolutional neural networks in a data flow form, and extract the multi-scale features through supervised representation learning;
an incremental training module, configured to selectively constrain drift of low-frequency components of the multi-scale features by using a multi-scale feature frequency domain distillation technology based on incremental training, and memorize knowledge learned by the parallel convolutional neural networks in old tasks;
an adaptive fusion module, configured to adaptively learn different fusion parameters according to different time spans of the input multi-scale data by using a multi-scale feature adaptive fusion technology, so as to enhance the ability to learn new tasks; and
an early warning module, configured to output a Nino3.4 index reflecting a change rule of one ocean phenomenon through fully connected layers according to the adaptively fused features, establish a mapping function of an extreme rainfall probability r based on the Nino3.4 index, and in response to predicting that the value r goes beyond a threshold value k, carry out rainstorm early warning, and carry out rainstorm prevention and control of transmission lines in advance.

8. A weather early device based on incremental learning, comprising: a processor and a memory, the memory storing program instructions, and the processor calling the program instructions stored in the memory to enable the device to implement the steps of the method according claim 1.

9. A computer readable storage medium storing computer programs, wherein the computer programs further comprise program instructions, and when the program instructions are executed by a processor, the processor implements the steps of the method according to claim 1.

10. The weather warning method based on incremental learning according to claim 2, wherein the selectively constraining the drift of the low-frequency components of the multi-scale features by using the multi-scale feature frequency domain distillation technology, and the memorizing the knowledge learned by the parallel convolutional neural networks in the old tasks are specifically as follows:
initializing a new parallel network Ω^{t} by using parameters of an old parallel network already trained in a last training phase when training new tasks every time, freezing the parameters of the old parallel network Ω^{t-1}, and simultaneously inputting training data into the new and old parallel networks;
performing discrete cosine transform on the multi-scale features hₜⁿ and hₜ₋₁ⁿ output by the new and old parallel networks, and drawing close to a Euclidean distance between the low-frequency components of the multi-scale features to constrain evolution of the features; and
defining the Euclidean distance as a multi-scale feature frequency domain distillation loss function:
$${L}_{dct - distillation} = {\sum }_{k = 1}^{K} {\sum }_{n = 1}^{2} ‖ {h}_{t}^{n , k} - {h}_{t - 1}^{n , k} ‖$$
where, t represents a training phase, hₜ^{n,k} represents first k low-frequency components of the output features of the new parallel network, hₜ₋₁^{n,k} represents first k low-frequency components of the output features of the old parallel network, and K is a length of a feature vector hₜⁿ.\

11. The computer readable storage medium of claim 9, wherein the multi-scale feature frequency domain distillation technology is used for making the output features of the new parallel network close to the output features of the old parallel network.

12. The computer readable storage medium of claim 9, wherein the multi-scale feature adaptive fusion technology comprises: multi-scale parallel networks, two bottleneck layers, two fully connected layers and one adaptive fusion function.

13. The computer readable storage medium of claim 9, wherein the selectively constraining the drift of the low-frequency components of the multi-scale features by using the multi-scale feature frequency domain distillation technology, and the memorizing the knowledge learned by the parallel convolutional neural networks in the old tasks are specifically as follows:
initializing a new parallel network Ω^{t} by using parameters of an old parallel network already trained in a last training phase when training new tasks every time, freezing the parameters of the old parallel network Ω^{t-1}, and simultaneously inputting training data into the new and old parallel networks;
performing discrete cosine transform on the multi-scale features hₜⁿ and hₜ₋₁ⁿ output by the new and old parallel networks, and drawing close to a Euclidean distance between the low-frequency components of the multi-scale features to constrain evolution of the features; and
defining the Euclidean distance as a multi-scale feature frequency domain distillation loss function:
$${L}_{dct - distillation} = {\sum }_{k = 1}^{K} {\sum }_{n = 1}^{2} ‖ {h}_{t}^{n , k} - {h}_{t - 1}^{n , k} ‖$$
where, t represents a training phase, hₜ^{n,k} represents first k low-frequency components of the output features of the new parallel network, hₜ₋₁^{n,k} represents first k low-frequency components of the output features of the old parallel network, and K is a length of a feature vector hₜⁿ.

14. The computer readable storage medium of claim 13, wherein
the old parallel network is a network already trained in a t-1th training phase;
the new parallel network is a new parallel network for initializing parameters through the network trained in the last phase, which is used for training in a current tth training phase; and
the parameters of the old parallel network are frozen in the whole new training phase to facilitate training of the new parallel network, and the old parallel network is deleted after the new parallel network is trained.

15. The computer readable storage medium of claim 12, wherein the adaptive fusion function is:
α₁=ζ(hₜ¹)=sigmoid(log(abs(ƒₛ(hₜ¹))))
α₂=ζ(hₜ²)=sigmoid(log(abs(ƒₛ(hₜ²))))
α₁ is importance of large-scale features to a final result, α₂ is importance of small-scale features to the final result, abs and log functions aim to distinguish large or small input values more significantly, a sigmoid function aims to map values of α₁ and α₂ to an interval (0, 1), and ƒₛ is a scoring layer used for outputting importance of each scale feature;
h_{fusion}α₁hₜ¹+α₂hₜ²
where, h_{fusion} is a final feature obtained after adaptive fusion of the multi-scale features, hₜ¹ represents an original large-scale feature, which is more suitable for short-term prediction, and hₜ² represents an original small-scale feature.

16. The weather early device of claim 8, wherein the multi-scale feature frequency domain distillation technology is used for making the output features of the new parallel network close to the output features of the old parallel network.

17. The weather early device of claim 8, wherein the multi-scale feature adaptive fusion technology comprises: multi-scale parallel networks, two bottleneck layers, two fully connected layers and one adaptive fusion function.

18. The weather early device of claim 8, wherein the selectively constraining the drift of the low-frequency components of the multi-scale features by using the multi-scale feature frequency domain distillation technology, and the memorizing the knowledge learned by the parallel convolutional neural networks in the old tasks are specifically as follows:
initializing a new parallel network Ω^{t} by using parameters of an old parallel network already trained in a last training phase when training new tasks every time, freezing the parameters of the old parallel network Ω^{t-1}, and simultaneously inputting training data into the new and old parallel networks;
performing discrete cosine transform on the multi-scale features hₜⁿ and hₜ₋₁ⁿ output by the new and old parallel networks, and drawing close to a Euclidean distance between the low-frequency components of the multi-scale features to constrain evolution of the features; and
defining the Euclidean distance as a multi-scale feature frequency domain distillation loss function:
$${L}_{dct - distillation} = {\sum }_{k = 1}^{K} {\sum }_{n = 1}^{2} ‖ {h}_{t}^{n , k} - {h}_{t - 1}^{n , k} ‖$$
where, t represents a training phase, hₜ^{n,k} represents first k low-frequency components of the output features of the new parallel network, hₜ₋₁^{n,k} represents first k low-frequency components of the output features of the old parallel network, and K is a length of a feature vector hₜⁿ.

19. The weather early device of claim 18, wherein
the old parallel network is a network already trained in a t-1th training phase;
the new parallel network is a new parallel network for initializing parameters through the network trained in the last phase, which is used for training in a current tth training phase; and
the parameters of the old parallel network are frozen in the whole new training phase to facilitate training of the new parallel network, and the old parallel network is deleted after the new parallel network is trained.

20. The weather early device of claim 17, wherein the adaptive fusion function is:
α₁=ζ(hₜ¹)=sigmoid(log(abs(ƒₛ(hₜ¹))))
α₂=ζ(hₜ²)=sigmoid(log(abs(ƒₛ(hₜ²))))
α₁ is importance of large-scale features to a final result, α₂ is importance of small-scale features to the final result, abs and log functions aim to distinguish large or small input values more significantly, a sigmoid function aims to map values of α₁ and α₂ to an interval (0, 1), and ƒₛ is a scoring layer used for outputting importance of each scale feature;
h_{fusion}=α₁hₜ¹+α₂hₜ²
where, h_{fusion} is a final feature obtained after adaptive fusion of the multi-scale features, hₜ¹ represents an original large-scale feature, which is more suitable for short-term prediction, and hₜ² represents an original small-scale feature.
